(19) United States
(12) Patent Application Publication
(10) Pub. No.: US 2025/0311683 A1
(43) Pub. Date: Oct. 9, 2025

(54) BORDER FOR A RAISED BED HAVING VARIABLE CAPACITY

(71) Applicant: Lorenz Kunststofftechnik GmbH, Wallenhorst-Hollage (DE)

(72) Inventor: Thomas Lorenz, Wallenhorst (DE)

(73) Assignee: Lorenz Kunststofftechnik GmbH, Wallenhorst-Hollage (DE)

(21) Appl. No.: 19/098,982

(22) Filed: Apr. 3, 2025

(30) Foreign Application Priority Data
Apr. 4, 2024 (EP) EP24168602.1

(51) Int. Cl. A01G 9/28

(52) U.S. Cl. CPC A01G 9/28

(57) ABSTRACT

A border for a raised bed includes a plurality of wall elements connected to form an enclosure. Each wall element has a first end face and an opposing second end face, both provided with fastening elements. Each wall element further includes a first longitudinal side extending between the first and second end faces and a second longitudinal side opposite the first, extending parallel thereto. The wall elements are connected to adjacent wall elements via plug connections at their first and second end faces. Each wall element has a cross-section perpendicular to the longitudinal sides, comprising alternately arranged first and second sections. The first and second sections extend on opposite sides of the longitudinal center axis of the cross-section. An intermediate bottom is positioned at a variable height within the enclosure by engaging the first and second sections of opposing wall elements, perpendicular to the wall elements.

### FIELD OF THE INVENTION

The present invention relates to a border for a raised bed, which, like conventional raised beds, is characterized by a height that makes it pleasant and easy on the back to work in. In contrast to previously known borders for raised beds, however, the invention offers the possibility of constructing a raised bed having a variable capacity adapted to the individual planting and is also characterized by a compact stackability in the disassembled state, which allows a space-saving packaging, for example in a cardboard box.

### BACKGROUND

Most of the raised beds known from the prior art that are not made of natural materials, such as natural stone, and are therefore not individual, are enclosed by metal or plastic frames, which are often mass-produced. The disadvantage of such metal or plastic frames lies in their lack of flexibility in terms of bed design, as the finished frames do not allow for any leeway in terms of customization. However, there are some known solutions that at least allow for partial customization.

For example, DE 20 2015 102 607 U1 describes a frame for a raised bed whose side walls consist of wood-concrete construction elements that delimit a space between them that can be filled with nutrient soil for planting the bed. Each side wall of the raised bed is formed by several of the building elements that are designed in a stepped manner at the front sides, which are connected to each other and to a stabilizing steel band by means of a steel pin. Due to the stepped front sides of the individual building elements, these can be joined together to form an exclusively rectangular raised bed, the side lengths and heights of which are, however, variable.

DE 10 2013 108 553 A1 describes a wall construction for gardening and landscaping that is suitable for constructing raised beds. The wall construction has various vertically positioned longitudinal elements, which in turn have a receptacle for wall elements to be inserted between the longitudinal elements. The raised beds that can be obtained in this way are variable in terms of their side length and height, but the capacity of the beds is also defined by their side length and height and is not variable.

Furthermore, DE 20 2005 000 418 U1 describes a border for a raised bed having vertically arranged walls made of fiber-reinforced plastic. The individual wall elements are either rectangular or U-shaped and are connected to each other by means of screw or riveted joints. However, the raised beds constructed in this way also have no variable capacity for a given dimension.

DE 20 2016 105 953 U1 describes a border for lawns and flowerbeds made of at least two interconnectable sheet metal profiles. Each sheet metal profile has recesses at one end and plug-in elements at the other end, which can engage in corresponding recesses of another sheet metal profile. The connected sheet metal profiles are fastened together by means of a connecting bolt. Due to the flexibility of the sheet metal profiles, they can also be formed into a closed border, wherein the capacity of the flower bed surrounded by the border is not variable.

DE 10 2017 104 344 B3 describes a border for raised beds that is composed of individual wall elements, wherein the individual wall elements can be arranged at any angle to one another using plug-in connections, preferably in the manner of a tongue and groove connection. The outer shape of the raised beds constructed in this way is therefore variable, although the capacity of the beds in a given shape is not variable.

Therefore, there is no satisfactory solution in the prior art for constructing raised beds that offer variable capacity for a given external shape, defined by the dimensions and arrangement of the wall elements from which it is composed. This would be desirable, however, as raised beds should be able to hold different amounts of soil material, e.g. potting soil, depending on their planting, in order to meet the individual needs of the plants on the one hand and at the same time to enable cost and material optimization. This is because deep-rooted plants require many times more soil to thrive in a raised bed than shallow-rooted plants. So for deep-rooted plants, a raised bed having correspondingly high wall elements is needed, enclosing a comparatively large volume to hold a lot of planting soil. However, if shallow-rooted plants are planted in the same raised bed instead of deep-rooted plants, which only require a significantly smaller volume of planting soil to thrive, then, in the case of conventional raised beds, due to the non-variable capacity, it is still necessary to fill up with soil to just below the upper end of the border formed by the wall elements, because the shallow-rooted plants must be planted at the same height within this border as the deep-rooted plants, in particular to meet their light requirements and to be easily accessible from the outside. However, a large part of the soil in the raised bed is then not used for planting, but only to fill the volume of the bed.

This problem is only insufficiently addressed in the prior art by the fact that there are tubs that can be mounted in a raised bed so that the part of the bed border enclosed by the wall elements that lies under the tub remains empty or filled with air and only the tub is filled with soil. Although this enables a cost and material saving, since only the tub and not the space below it that is surrounded by the border needs to be filled with soil, but it does limit the outer shape of the raised bed due to the dimensions of the tub, the edges of which have to fit snugly against the raised bed border formed by the wall elements so as not to create unsightly gaps between the tub and the border formed by the wall elements.

### OBJECT OF THE INVENTION

It is the object of the present invention to provide an alternative border for a raised bed that overcomes the disadvantages of the prior art and is characterized in particular by the option of variable adjustability of an individual capacity and compact storage in a disassembled state.

### GENERAL DESCRIPTION OF THE INVENTION

The invention achieves this object with the features of the claims and in particular with a border for a raised bed, comprising several wall elements connected to one another to form an enclosure, each of which wall elements having a first end face and an opposing second end face, which respectively have fastening elements, each wall element also having a first longitudinal side extending between the first end face and the second end face and a second longitudinal side lying opposite the first longitudinal side and also extending between the first end face and the second end face in parallel to the first longitudinal side, and each wall element being connected to an adjacent wall element by means of a plug connection at its first end face and at its second end face.

Each wall element of the border according to the invention has, perpendicular to the two opposite longitudinal sides, a cross section extending between them, which comprises alternately arranged first and second sections, wherein, with respect to a longitudinal center axis of the cross section, the first sections and the second sections extend on opposite sides of the longitudinal center axis, wherein an intermediate bottom is or can be arranged at variable heights in perpendicular to the wall elements within the border formed by the wall elements by being or by coming into engagement with the first or second sections of opposing wall elements.

The first and second sections of the cross-section of the wall elements perpendicular to their opposing longitudinal sides can, for example, be bulges on opposite sides of the longitudinal center axis of the cross-section, e.g. semicircular or angular bulges. It is important that the first sections of the cross-sections of each wall element are identically shaped and arranged and that the second sections of the cross-sections of each wall element are also identically shaped and arranged, so that in the disassembled state, the individual wall elements can be stacked on top of each other without gaps, which in turn allows compact packaging, in particular compact packaging of all wall elements belonging to a border in a single box. Therefore, preferably all wall elements having the same dimensions are identical. According to a preferred embodiment, wall elements having the same dimensions can be stacked in a space-saving manner in the disassembled state, in which they do not form an enclosure, by placing the first sections and the second sections of several wall elements on top of each other without any space in between.

Wall elements having different dimensions preferably differ only in their length and/or height, but each also has a cross-section perpendicular to its opposing longitudinal sides, which comprises first and second sections arranged alternately, the first sections and the second sections extending on opposite sides of the longitudinal center axis with respect to a longitudinal center axis of the cross-section. In the case of wall elements that differ only in their length, the cross-section is preferably identical, but also in the case of wall elements that differ in their height, the shape and spacing of the first and second sections is preferably identical, wherein the number of first and second sections may be different. In this way, it is possible to stack the wall elements, which are of different lengths and/or heights, in a compact manner without gaps, in that the first and second sections of wall elements that are arranged on top of one another come to lie on top of one another. In this embodiment, it is therefore also possible, for example, to pack all the components of the border, which is mainly composed of the individual wall elements, in just one box.

In conventional raised beds, the filling material, e.g. nutrient soil or soil, is usually arranged up to a filling height between 0.50 m and 1.00 m within a border formed by wall elements, which allows a comfortable and back-friendly posture when planting or working in the bed. Most plants, however, do not require such a large amount of the filling material needed to reach the aforementioned height in order to thrive, so that a large part of the filling material only serves to fill the space in order to achieve the desired filling height within the border.

The present invention addresses this problem by providing an intermediate bottom that can be arranged at any height between the enclosure formed by the wall elements. This intermediate bottom of the border according to the invention can be formed in one piece or comprise several intermediate bottom parts. Irrespective of whether the intermediate bottom is formed in one piece or in several pieces, it preferably has, like the wall elements, a cross-section perpendicular to two opposite sides, which comprises alternately arranged first and second sections, wherein the first sections and the second sections extend on opposite sides of the longitudinal center axis with respect to a longitudinal center axis of the cross-section. It is particularly preferred that this cross-section of the intermediate bottom is at least in sections identical to the cross-section of the wall elements, so that the intermediate bottom can be stored in a space-saving manner on a wall element when the border is disassembled, wherein the first and second sections of the cross-sections of the intermediate bottom and the wall elements preferably come to lie on top of each other without significant spaces therebetween.

According to a preferred embodiment of the border according to the invention, each wall element has a terminal profile on one of its longitudinal sides, the profile comprising or consisting of a plate, wherein the wall element can be arranged with the terminal profile on a substrate. A plate is understood to be a flat structure which in particular comprises a surface which is at least twice as large as the longitudinal side on which the terminal profile is arranged. The terminal profile significantly increases the stability of the border according to the invention on the ground. In addition, when the border is erected on non-solid, yielding ground, e.g. soil or grass, the weight of the border is distributed over a larger area by the larger surface area that the terminal profile brings with it, which reduces or prevents the border from sinking into the ground.

According to a further preferred embodiment, the wall elements of the border according to the invention are connected to each other exclusively by means of plug connections. For this purpose, the border according to the invention for a raised bed comprises a plurality of wall elements, each having fastening elements on their first end face and on their opposite second end face. Preferably, both the fastening elements of the first end face and the fastening elements of the second end face are hook-shaped, with the hooks of the first end face having a different, in particular opposite, orientation from the hooks of the second end face. This makes it possible for a wall element to be connected at its first end face to the second end face of another wall element via a plug connection and at its second end face to the first end face of a further wall element via a plug connection.

According to the invention, each wall element has two opposite end faces which respectively connect the two opposite longitudinal sides of the wall elements, the end faces and the longitudinal sides defining between them a substantially rectangular area. Therein, a border according to the invention which comprises a plurality of interconnected wall elements or consists of these can be composed of identically or differently dimensioned wall elements. In the case of differently dimensioned wall elements, these can, for example, have a different length, i.e. longitudinal sides having a different length, or also a different height, i.e. end faces having a different length. A border for a raised bed having a different height in the individual wall elements is suitable, for example, for the construction of a raised bed on a sloping or inclined surface.

The hooks located on the first and second end faces may be distributed over the entire length of the end faces or only over part of their length. Preferably, the hooks are formed in one piece with the wall element.

According to a preferred embodiment of the invention, the hooks are substantially in the form of a right angle, wherein on the first end face the one leg of the angle is also arranged at a right angle at the first end face, and the second leg of the angle extends in parallel to the first end face and points in the direction of the first longitudinal side. Similarly, on the second end face, one leg of the angle is also arranged at a right angle to the second end face, with the second leg of the angle running parallel to the second end face and pointing in the direction of the second longitudinal side.

According to an alternative embodiment, the hooks on the first and second end faces may also be concave or convex.

A particular advantage of the border for a raised bed according to the invention is that the individual wall elements can be put together very easily, quickly and without tools. The plug connection, by means of which the wall elements are connected to one another by means of their corresponding fastening elements, is completely sufficient for connecting the individual wall elements and ensures good stability, so that additional connection of the wall elements by means of additional fastening means, e.g. screws or nails, is not necessary. Accordingly, the wall elements are preferably connected to each other exclusively by means of the plug connections, and a preferred embodiment of the border for a raised bed according to the invention consists of the wall elements connected by means of plug connections.

Optionally, the wall elements belonging to the same side of the border for a raised bed are spaced apart from each other by a batten that is arranged in parallel to and between the longitudinal sides of two adjacent wall elements.

Advantageously, the wall elements forming the border for a raised bed according to the invention are made of plastic, wood or metal and optionally have a coating. A particularly preferred material for the wall elements is fiber-reinforced plastic.

The advantage of the present invention is that the border for a raised bed according to the invention can be extended in both length and width depending on the requirements, by connecting further wall elements to an existing connection of wall elements. This is possible both at the time of the initial construction of the raised bed and at a later time.

The invention also relates to a process for constructing a raised flower bed, which comprises the following steps:
providing several wall elements, each of which having a first end face and an opposing second end face, which end faces have fastening elements, each wall element also having a first longitudinal side extending between the first end face and the second end face and a second longitudinal side which is located opposite the first longitudinal side and is also extending between the first end face and the second end face in parallel to the first longitudinal side, each wall element having, in perpendicular to the two opposing longitudinal sides, a cross-section extending between these longitudinal sides, which cross-section comprises alternating first and second sections, wherein the first sections and the second sections with respect to a longitudinal center axis of the cross-section extend on opposite sides of the longitudinal center axis;
connecting each wall element at its first end face and at its second end face to an adjacent wall element, the connection being made by means of a plug connection and an enclosure being formed thereby; and
arranging an intermediate bottom perpendicular to the wall elements at any height within the enclosure formed by the wall elements, by engaging the intermediate bottom with the first and second sections, respectively, of opposing wall elements, preferably also by means of a plug connection.

In the process for constructing a raised bed according to the invention, the wall elements are designed as described with reference to the border for a raised bed according to the invention. By connecting any number of wall elements, which optionally vary at least partially in their length and/or height, raised beds can be constructed that correspond to an individually desired geometry or adapt to a given space and/or a given substrate.

In the process according to the invention, filling material, e.g. soil or plant substrate, is preferably arranged on top of the intermediate bottom, while an air-filled space remains below the intermediate bottom, which is enclosed by the intermediate bottom, a plurality of wall elements and the substrate on which the wall elements are arranged to form an enclosure.

### DETAILED DESCRIPTION OF THE INVENTION

The invention will now be described in more detail with reference to the FIG.s, in which

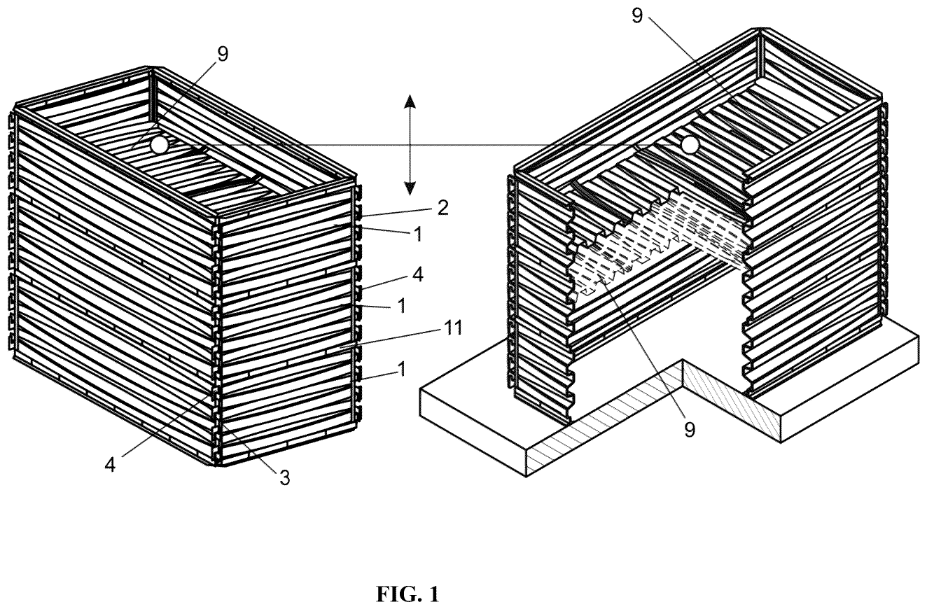

FIG. 1 shows a schematic view of a border for a raised bed having variable (storage) capacity according to the invention,

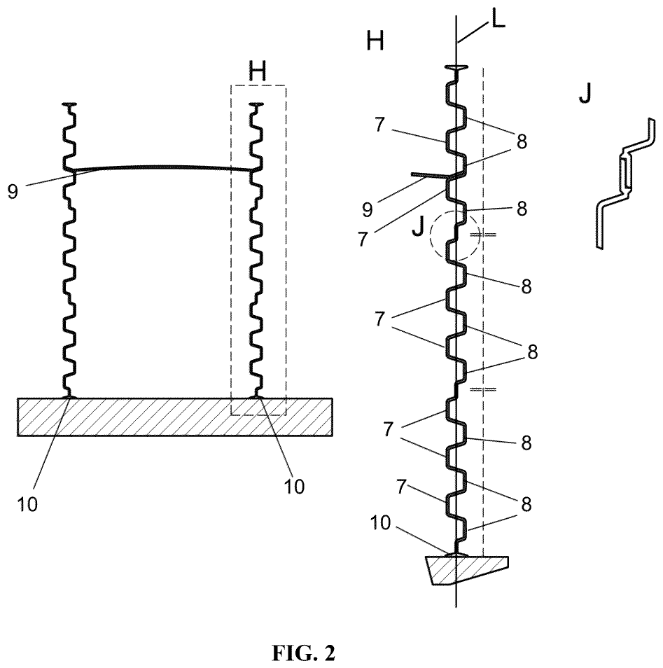

FIG. 2 shows a schematic sectional view of a border for a raised bed according to the invention,

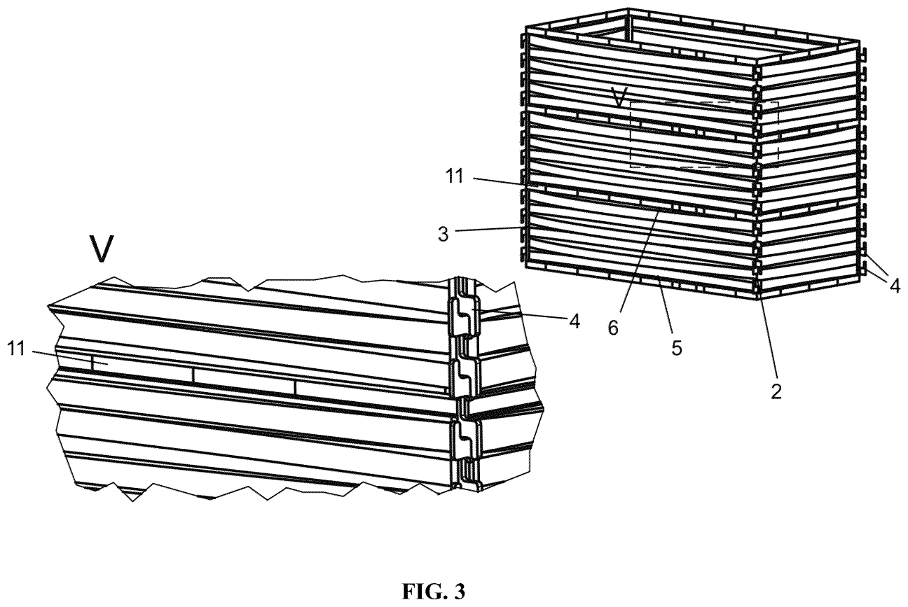

FIG. 3 shows a schematic view of a further embodiment of a border for a raised bed in accordance with the invention,

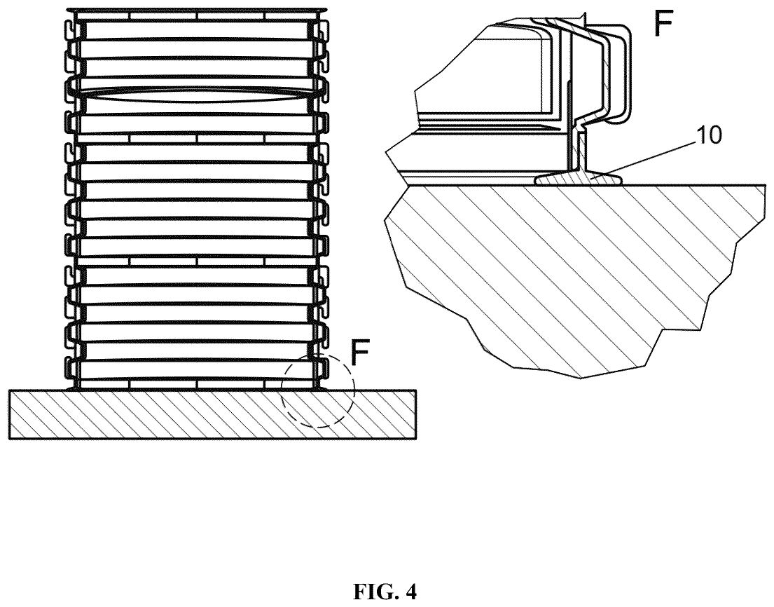

FIG. 4 shows a schematic view of a further embodiment of a border for a raised bed in accordance with the invention,

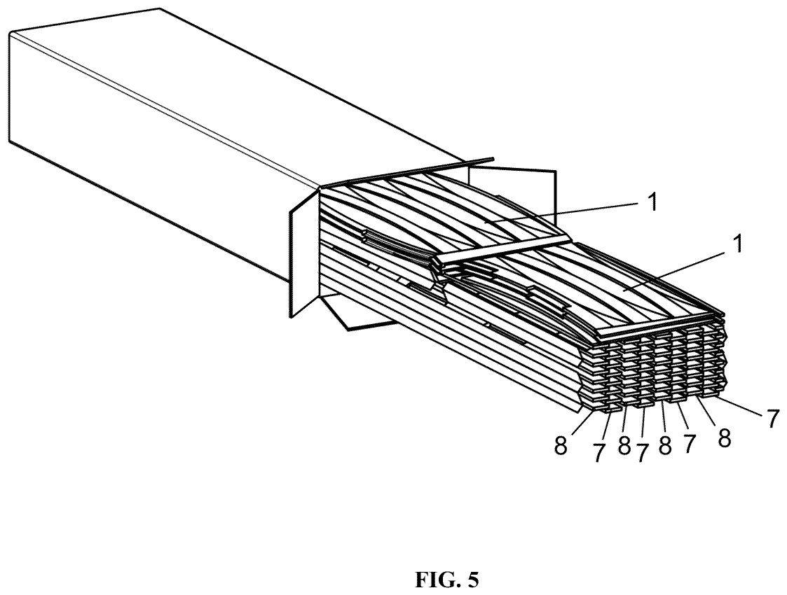

FIG. 5 shows a schematic view of a compact packaging of components of a border for a raised bed in accordance with the invention in a box,

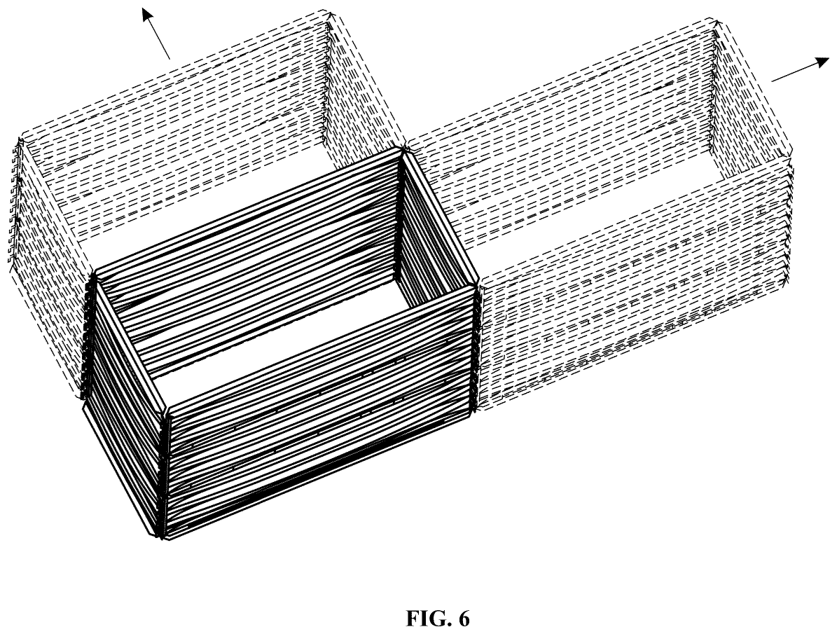

FIG. 6 shows a schematic view of a further embodiment of a border for a raised bed in accordance with the invention.

In the FIG.s, the same reference numbers denote parts having the same function.

FIG. 1 shows a schematic view of a border for a raised bed having variable (storage) capacity according to the invention. This border comprises three wall elements 1 arranged one above the other on each side, with battens 11 being arranged as spacers between the wall elements 1 belonging to the same side. The wall elements 1 each have a first end face 2 and an opposite second end face 3, which respectively have fastening elements 4, each wall element 1 furthermore having a first longitudinal side 5 running between the first end face 2 and the second end face 3 and a second longitudinal side 6 lying opposite the first longitudinal side and also running between the first end face 2 and the second end face 3 in parallel to the first longitudinal side 5. Each wall element 1 is connected to an adjacent wall element 1 at its first end face 2 and at its second end face 3 by means of a plug connection, in the illustrated embodiment at a right angle in each case. Within the border formed by the twelve wall elements 1, an intermediate bottom 9 is arranged at a 900 angle to the wall elements 1 contacting it. In the left part of the drawing, this intermediate bottom 9 is arranged approximately in the upper third of the border formed by the wall elements 1. The arrow connecting the left and right parts of the drawing indicates that the intermediate bottom 9 is height-adjustable. In the right part of the drawing, the intermediate bottom 9 is shown as a dashed line at a different height, approximately halfway up the boundary formed by the wall elements 1.

The left-hand side of FIG. 2 shows a schematic cross-sectional view of a raised bed border according to the invention, in which the intermediate bottom 9 is arranged approximately in the upper third of the border formed by the wall elements 1. The section H shows that each wall element 1 perpendicular to the two opposite long sides 5, 6 has a cross-section running between them, comprising alternately arranged first sections 7 and second sections 8, wherein the first sections 7 and the second sections 8 with respect to a longitudinal center axis L of the cross-section extend on opposite sides of the longitudinal center axis L. The intermediate bottom 9 is arranged perpendicular to the wall elements 1 at a variable height within the border formed by the wall elements 1 by engaging the first and second sections 7, 8 of opposite wall elements 1, for example, the intermediate bottom 9 can rest at any height on the opposite first and second sections 7, 8 of opposing wall elements 1. Section J shows, in the enlarged view, the connection of two wall elements 1, one arranged on top of the other.

FIG. 3 shows a perspective view of a further embodiment of a border for a raised bed according to the invention with an enlarged section V. A preferred plug connection of adjacent wall elements 1 is shown here. The wall elements 1 have fastening elements 4 on their first end face 2 and on their second end face 3, which are hook-shaped, with the hooks of the first end face 2 having an orientation opposite to that of the hooks of the second end face 3. In this way, each wall element 1 is connected at its first end face 2 to the second end face 3 of another wall element 1 via a plug connection and at its second end face 3 to the first end face 2 of a further wall element 1 via a plug connection. Adjacent wall elements 1 are spaced apart from one another by a batten 11.

FIG. 4 shows a schematic view of a further embodiment of a border for a raised bed according to the invention. In this embodiment, each wall element 1 has a terminal profile 10 on one of its longitudinal sides 5, 6 which comprises a plate with which the terminal profile 10 is arranged on a substrate. In the enlarged section F, it can be seen that the terminal profile 10 increases the surface with which the sides of the border formed by the wall elements 1 contact the substrate. The terminal profile 10 thus distributes the weight of the border over a larger area, significantly reducing the sinking of the border into non-solid ground.

FIG. 5 shows the second main advantage of the present invention, in addition to the variable capacity, namely the compact stackability and storage of a large number of wall elements 1 in a package. This is made possible by the first sections 7 and the second sections 8 of each wall element 1 being placed on top of each other without significant gaps when the wall elements 1 are stacked.

FIG. 6 shows how a border for a raised bed according to the invention can be extended in different directions by arranging further wall elements 1 in a desired direction.

The features of the invention disclosed in the foregoing description, claims and FIG.s may be essential for realizing the invention in its various embodiments, both individually and in any combination.

### LIST OF REFERENCE NUMERALS

1 wall element
2 first end face
3 second end face
4 fastening elements
5 first longitudinal side
6 second longitudinal side
7 first section
8 second section
9 intermediate bottom
9a intermediate bottom parts
10 terminal profile
11 batten

What is claimed is:

1. A border for a raised bed, comprising a plurality of wall elements (1) connected to one another to form an enclosure, each wall element (1) having a first end face (2) and an opposing second end face (3), each end face (2, 3) having fastening elements (4), each wall element (1) also having a first longitudinal side (5) extending between the first end face (2) and the second end face (3) and a second longitudinal side (6) which is located opposite the first longitudinal side (5) and also extends between the first end face (2) and the second end face (3) in parallel to the first longitudinal side (5), each wall element (1) being connected to an adjacent wall element (1) by means of a plug connection at its first end face (2) and at its second end face (3), each wall element (1) having, perpendicular to the two opposing longitudinal sides (5, 6), a cross section extending between the two opposing longitudinal sides (5, 6), which comprises alternately arranged first and second sections (7, 8), wherein the first sections (7) and the second sections (8) with respect to a longitudinal center axis (L) of the cross-section extend on opposite sides of the longitudinal center axis (L), wherein an intermediate bottom (9) is arranged perpendicularly to the wall elements (1) at a variable height within the border formed by the wall elements (1) by engaging in the first and second sections (7, 8), respectively, of opposing wall elements (1).

2. The border for a raised bed according to claim 1, wherein the intermediate bottom (9) comprises several intermediate bottom parts (9a).

3. The border for a raised bed according to claim 1, wherein each wall element (1) has a terminal profile (10) on one of its longitudinal sides (5, 6) which comprises or consists of a plate, wherein the wall element (1) can be arranged with the terminal profile (10) on a substrate.

4. The border for a raised bed according to claim 1, wherein wall elements (1) having the same dimensions in the dismantled state, in which they do not form an enclosure, can be stacked in a space-saving manner, in that the first sections (7) and the second sections (8) of a plurality of wall elements (1) come to rest on one another without a gap therebetween when these wall elements (1) are arranged one above the other.

5. The border for a raised bed according to claim 1, wherein the wall elements (1) are connected to one another exclusively by means of plug connections.

6. The border for a raised bed according to claim 1, wherein wall elements (1) belonging to the same side of the border for a raised bed are spaced apart from one another by a batten (11) arranged between the longitudinal sides (4, 5) of two adjacent wall elements (1).

7. The border for a raised bed according to claim 1, wherein the wall elements (1) are made of plastic, wood or metal and optionally have a coating.

8. The border for a raised bed according to claim 1, wherein two wall elements (1) are connected to one another at an angle of approximately 90°, wherein the walls of the border formed by the wall elements (1) can be extended at any time in any direction by one or more wall elements (1).

9. A process for erecting a raised bed comprising the steps of
providing a plurality of wall elements (1), each of the wall elements (1) having a first end face (2) and an opposite second end face (3), which respectively have fastening elements (4), each wall element (1) also having a first longitudinal side (5) extending between the first end face (2) and the second end face (3) and a second longitudinal side (6) lying opposite the first longitudinal side and also extending between the first end face (2) and the second end face (3) in parallel to the first longitudinal side (5), each wall element (1) having, perpendicular to the two opposite longitudinal sides (5, 6), a cross section extending between the longitudinal sides (5, 6) which comprises alternately arranged first and second sections (7, 8), wherein the first sections (7) and the second sections (8) with respect to a longitudinal center axis (L) of the cross-section extend on opposite sides of the longitudinal center axis (L);
connecting each wall element (1) at its first end face (2) and at its second end face (3) to an adjacent wall element (1), the connection being made by means of a plug connection and an enclosure being formed as a result; and
arranging an intermediate bottom (9) perpendicular to the wall elements (1) at any height within the enclosure formed by the wall elements (1) by engaging the intermediate bottom (9) with the first and second sections (7, 8) of opposing wall elements (1).

10. The process according to claim 9, wherein filling material is arranged on the intermediate bottom (9), while an air-filled space remains below the intermediate bottom (9), which is defined by the intermediate bottom (9), a plurality of wall elements (1) and the substrate on which the wall elements (1) are arranged to form an enclosure.
